(19) United States
(12) Patent Application Publication
(10) Pub. No.: US 2024/0324630 A1
(43) Pub. Date: Oct. 3, 2024

(54) METHODS OF MAKING SHELF STABLE AND READY TO DRINK PLANT PROTEIN BEVERAGES

(71) Applicant: PepsiCo, Inc., Purchase, NY (US)

(72) Inventor: Seyhun GEMILI, Montville, NJ (US)

(21) Appl. No.: 18/194,361

(22) Filed: Mar. 31, 2023

(51) Int. Cl. A23L 2/66; A23J 3/14; A23L 33/12; A23L 33/185

(52) U.S. Cl. CPC A23L 2/66; A23J 3/14; A23L 33/12; A23L 33/185

(57) ABSTRACT

Plant-based protein beverages containing phospholipids and oilseed proteins are disclosed. Adding lecithin to the beverage increases the beverages' heat stability and solubility while decreasing their viscosity.

### FIELD

The present disclosure provides beverages containing plant-based proteins. The beverages contain phospholipids that increase the beverages' heat stability and solubility while decreasing their viscosity.

### BACKGROUND

Producing ready-to-drink protein beverages requires careful selection of the right protein and non-protein ingredients, and the right processing conditions to provide shelf stability and high protein quality (i.e., the protein is heat stable, highly soluble and provides all of the essential amino acids). High protein quality can be achieved by blending plant-based proteins from different sources like legumes (e.g. pea protein), cereals (e.g. rice protein) and oilseeds (e.g. canola protein). Despite its utility, canola protein is known for its poor solubility and poor heat stability, both of which can negatively impact shelf stability and sensory properties of a beverage comprising this protein. Accordingly, there is a need for ready-to-drink protein beverages that have high amounts of protein, good shelf stability, and provide a good sensory experience to the consumer.

### SUMMARY

In certain aspects, the present disclosure provides a beverage comprising:
a. lecithin; and
b. one or more oilseed proteins;
wherein the beverage has one or both of the following:
   i. a protein solubility of at least 80%; and
   ii. a viscosity of less than 250 cP as measured at about 20° C. and 60 RPM.

In some aspects, the lecithin is plant-derived lecithin. In some aspects, the lecithin is from sunflower. In some aspects, the lecithin is native. In other aspects, the lecithin is hydrolyzed.

In some aspects, the one or more oilseed proteins is selected from the group consisting of canola protein, hemp seed protein, pumpkin seed protein, sesame seed protein, sunflower seed protein, chia seed protein, cotton seed protein, flax seed protein, and a mixture thereof. In some aspects, the one or more oilseed proteins is canola protein.

In certain aspects, the beverage further comprises one or more plant-based proteins. In some aspects, the one or more plant-based proteins is selected from the group consisting of one or more pulse proteins, one or more cereal proteins, and a mixture thereof. In some aspects, the one or more plant-based proteins is a mixture of one or more pulse proteins and one or more cereal proteins. In some aspects, the one or more pulse proteins is selected from the group consisting of pea protein, bean protein, chickpea protein, lentil protein, and a mixture thereof. In some aspects, the one or more pulse proteins is pea protein. In some aspects, the one or more cereal proteins is selected from the group consisting of rice protein, wheat protein, corn protein, barley protein, oat protein, millet protein, sorghum protein, rye protein, and a mixture thereof. In some aspects, the one or more cereal proteins is rice protein. In some aspects, the one or more plant-based proteins is a mixture of pea protein and rice protein.

In certain aspects, the lecithin and one or more oilseed proteins are present in a weight ratio from about 1:5 to about 1:1000. In some aspects, the lecithin and the one or more oilseed proteins are present in a weight ratio from about 1:5 to about 1:30.

In some aspects, the one or more oilseed proteins comprises from about 0.1 wt % to about 10 wt % by weight of the beverage. In some aspects, the one or more plant-based proteins comprises from about 5 wt % to about 15 wt % of the beverage.

In some aspects, the beverage further comprises one or more oils. In some aspects, the one or more oils is selected from the group consisting of soybean oil, sunflower oil, vegetable oil, rapeseed oil, olive oil, hempseed oil, avocado oil, flaxseed oil, peanut oil, coconut oil, sesame oil, corn oil, and a mixture thereof. In some aspects, the one or more oils is sunflower oil.

In certain aspects, the beverage further comprises one or more processing aids. In some aspects, the one or more processing aids are selected from the group consisting of potassium carbonate, sodium bicarbonate, sodium carbonate, ascorbic acid, citric acid, acetic acid, phosphoric acid, malic acid, tripotassium phosphate, sodium hydroxide, potassium hydroxide, dipotassium phosphate, and an antifoaming agent.

In some aspects, the present disclosure provides a method of preparing a beverage as described herein, the method comprising adding one or more oilseed proteins to an aqueous solution optionally comprising one or more processing aids to form a mixture and adding lecithin to the mixture to form a final mixture. In some aspects, the method further comprises subjecting the final mixture to thermal processing. In some aspects, the method further comprises homogenizing the final mixture.

### BRIEF DESCRIPTION OF THE FIGURES

FIG. 1 is a bar graph depicting the percentage of canola protein precipitate in the absence and presence of lecithin.

FIG. 2 is a bar graph depicting protein solubility in various liquid protein beverage products in the presence and absence of canola protein and in the presence of lecithin after heat treatment.

FIG. 3 shows the viscosity profiles of liquid protein beverage products in the presence and absence of canola protein and in the presence of lecithin after heat treatment measured at various speeds.

FIG. 4 is a bar graph depicting the percentage of protein soluble in liquid protein beverage slurries containing different types of lecithin after thermal processing.

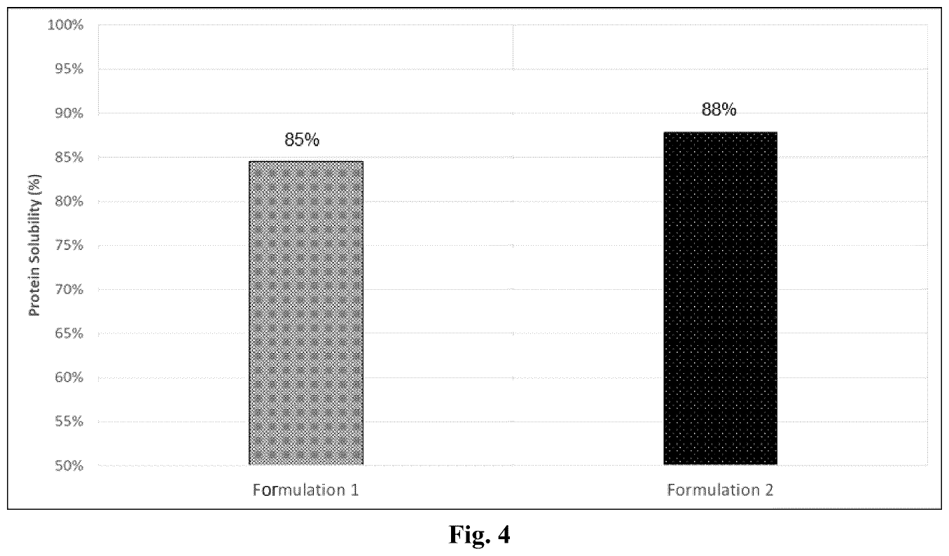

FIG. 5 shows the viscosity profiles of liquid protein beverage slurries containing different types of lecithin after thermal processing.

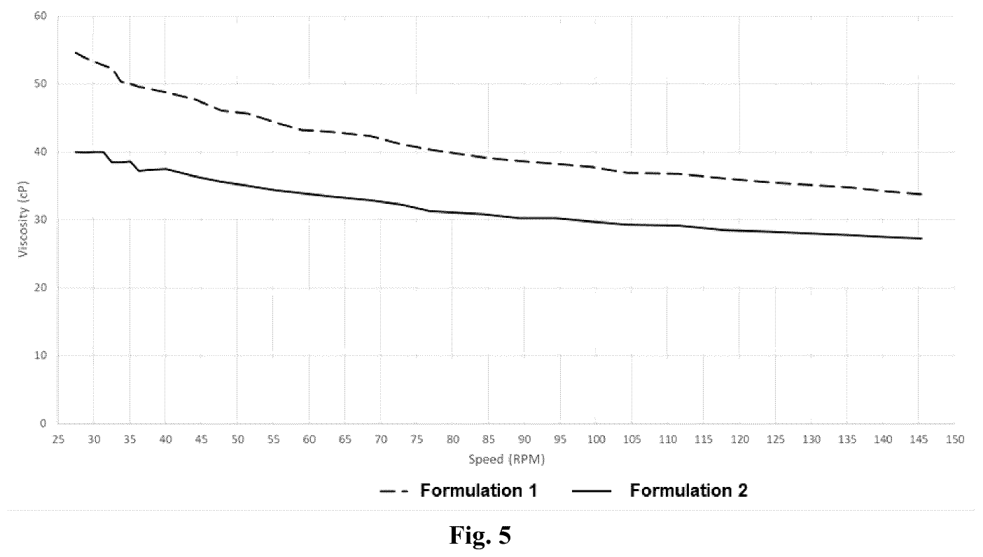

### DETAILED DESCRIPTION

### Definitions

The singular forms “a,” “an,” and “the” include plural referents unless the context clearly dictates otherwise.

As used herein, the term “or” is a logical disjunction (i.e., and/or) and does not indicate an exclusive disjunction unless expressly indicated as such with the terms “either,” “unless,” “alternatively,” and words of similar effect.

As used herein, the term “about” refers to +10% of the noted value, unless otherwise specified, and unless the upper bound of the range would exceed 100% of the composition, in which case the upper limit of the range is limited to 99.99%. Thus, and by way of example only, a composition comprising about 10 weight percent of a given ingredient could have from 9 to 11 weight percent of the ingredient. Similarly, a composition comprising about 95 weight percent of a given ingredient could have from 85.5 to 99.99 weight percent of the ingredient in the composition.

As used herein, the phrase “antifoaming agent,” refers to a substance or substances that reduce and/or hinder the formation of foam during the processing of a liquid. In some aspects, antifoaming agents can be used to prevent formation of a foam, and in some aspects, antifoaming agents can be used to break foams that have already formed. Examples of antifoaming agents include, but are not limited to, dimethylpolysiloxane, n-butoxypoly(oxyethylene)poly(oxypropylene)glycol, monoester of alpha-hydro-omega-hydroxypoly(oxyethylene) poly(oxypropylene) poly(oxyethylene) blockcopolymer derived from low erucic acid rapeseed oil, refined soybean oil, hydrophobic silica, one or more polysorbates, mono, di-, and triglycerides, silicon dioxide, oleic acid, and combinations thereof.

As used herein, the phrase “cereal protein,” refers to a protein derived from a grain that has edible components. Examples of cereal proteins include, but are not limited to, wheat protein, rice protein, maize protein, corn protein, oat protein, barley protein, rye protein, millet protein, and sorghum protein.

As used herein, the term “lecithin,” refers to a complex mixture of phospholipids commonly used as a food additive to emulsify foods. Lecithin can be found in both animals (“animal-based lecithin) and in plants (“plant-based lecithin”). As used herein, the phrase “native lecithin” refers to lecithin that is derived from its source and not subjected to further modification. As used herein, the phrase “hydrolyzed lecithin” refers to lecithin that has had the fatty acid of a portion of the phospholipids removed enzymatically which makes the lecithin more hydrophilic.

As used herein, the phrase “oilseed protein,” refers to a protein derived from a seed or crop grown mainly for oil. Examples of oilseed proteins include, but are not limited to, canola protein, hemp seed protein, pumpkin seed protein, sesame seed protein, sunflower seed protein, chia seed protein, cotton seed protein, and flax seed protein.

As used herein, the phrase “plant-based protein,” refers to a protein derived from a plant. Examples of plant-based proteins include, but are not limited to, cereal proteins, oilseed proteins, and pulse proteins.

As used herein, the phrase “processing aid” refers to a substance or substances that can be used to facilitate the manufacturing of a food product. Processing aids can be used to improve product quality and consistency, enhance nutrition, maintain product wholesomeness, enhance shelf life, and assist with packing and transportation. Exemplary processing aids include, but are not limited to, potassium carbonate, sodium bicarbonate, sodium carbonate, acetic acid, ascorbic acid, citric acid, phosphoric acid, malic acid, tripotassium phosphate, sodium hydroxide, potassium hydroxide, dipotassium phosphate, and antifoaming agents as well as agents such as antimicrobial agents.

As used herein, the phrase “pulse protein,” refers to a protein derived from the edible seed of a legume plant. Examples of pulse proteins include, but are not limited to, pea protein, bean protein, chickpea protein, and lentil protein.

All percentages provided in this specification are percentages by weight, unless specifically indicated otherwise.

### Beverages

The present disclosure provides beverages containing oilseed proteins that are shelf stable and provide a good sensory experience for the consumer. In some aspects, the beverages can comprise the oilseed protein and lecithin. In some aspects, the lecithin is plant-derived lecithin. In some aspects, the lecithin is from sunflower. In some aspects the lecithin is native lecithin. In some aspects, the lecithin is hydrolyzed lecithin.

In certain aspects, the one or more oilseed proteins can be selected from the group consisting of canola protein, hemp seed protein, pumpkin seed protein, sesame seed protein, sunflower seed protein, chia seed protein, cotton seed protein, flax seed protein, and a mixture thereof. In some aspects, the one or more oilseed proteins can be canola protein.

In some aspects, the one or more oilseed proteins can be present in the beverage in an amount from about 0.05 wt % to about 20 wt %. In some aspects, the one or more oilseed proteins can be present in the beverage in an amount from about 0.06 wt % to about 15 wt %. In some aspects, the one or more oilseed proteins can be present in the beverage in an amount from about 0.07 wt % to about 13 wt %. In some aspects, the one or more oilseed proteins can be present in the beverage in an amount from about 0.08 wt % to about 12 wt %. In some aspects, the one or more oilseed proteins can be present in the beverage in an amount from about 0.09 wt % to about 11 wt %. In some aspects, the one or more oilseed proteins can be present in the beverage in an amount from about 0.1 wt % to about 10 wt %. In some aspects, the one or more oilseed proteins can be present in the beverage in an amount from about 0.1 wt % to about 9 wt %. In some aspects, the one or more oilseed proteins can be present in the beverage in an amount from about 0.1 wt % to about 8 wt %. In some aspects, the one or more oilseed proteins can be present in the beverage in an amount from about 0.1 wt % to about 7 wt %. In some aspects, the one or more oilseed proteins can be present in the beverage in an amount of from about 0.1 wt % to about 6 wt %. In some aspects, the one or more oilseed proteins can be present in the beverage in an amount of from about 0.1 wt % to about 5 wt %. In some aspects, the one or more oilseed proteins can be present in the beverage in an amount of about 0.05 wt %, about 0.06 wt %, about 0.07 wt %, about 0.08 wt %, about 0.09 wt %, about 0.10 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 3.0 wt %, about 4.0 wt %, about 5.0 wt %, about 6.0 wt %, about 7.0 wt %, about 8.0 wt %, about 9.0 wt %, about 10 wt %, about 11 wt %, about 12 wt %, about 13 wt %, about 14 wt %, about 15 wt %, about 16 wt %, about 17 wt %, about 18 wt %, about 19 wt %, or about 20 wt %.

In some aspects, the one or more oilseed proteins can be canola protein. In some aspects, the canola protein can be present in the beverage in an amount from about 0.05 wt % to about 20 wt %. In some aspects, the canola protein can be present in the beverage in an amount from about 0.06 wt % to about 15 wt %. In some aspects, the canola protein can be present in the beverage in an amount from about 0.07 wt % to about 13 wt %. In some aspects, the canola protein can be present in the beverage in an amount from about 0.08 wt % to about 12 wt %. In some aspects, the canola protein can be present in the beverage in an amount from about 0.09 wt % to about 11 wt %. In some aspects, the canola protein can be present in the beverage in an amount from about 0.1 wt % to about 10 wt %. In some aspects, the canola protein can be present in the beverage in an amount from about 0.1 wt % to about 9 wt %. In some aspects, the canola protein can be present in the beverage in an amount from about 0.1 wt % to about 8 wt %. In some aspects, the canola protein can be present in the beverage in an amount from about 0.1 wt % to about 7 wt %. In some aspects, the canola protein can be present in the beverage in an amount of from about 0.1 wt % to about 6 wt %. In some aspects, the canola protein can be present in the beverage in an amount of from about 0.1 wt % to about 5 wt %. In some aspects, the canola protein can be present in the beverage in an amount of about 0.05 wt %, about 0.06 wt %, about 0.07 wt %, about 0.08 wt %, about 0.09 wt %, about 0.10 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 3.0 wt %, about 4.0 wt %, about 5.0 wt %, about 6.0 wt %, about 7.0 wt %, about 8.0 wt %, about 9.0 wt %, about 10 wt %, about 11 wt %, about 12 wt %, about 13 wt %, about 14 wt %, about 15 wt %, about 16 wt %, about 17 wt %, about 18 wt %, about 19 wt %, or about 20 wt %.

In some aspects, the lecithin and the one or more oilseed proteins can be present in a weight ratio from about 1:1 to about 1:1400. In some aspects, the lecithin and the one or more oilseed proteins can be present in a weight ratio from about 1:2 to about 1:1300. In some aspects, the lecithin and the one or more oilseed proteins can be present in a weight ratio from about 1:3 to about 1:1200. In some aspects, the lecithin and the one or more oilseed proteins can be present in a weight ratio from about 1:4 to about 1:1100. In some aspects, the lecithin and the one or more oilseed proteins can be present in a weight ratio from about 1:5 to about 1:1000. In some aspects, the lecithin and the one or more oilseed proteins can be present in a weight ratio from about 1:5 to about 1:900. In some aspects, the lecithin and the one or more oilseed proteins can be present in a weight ratio from about 1:5 to about 1:800. In some aspects, the lecithin and the one or more oilseed proteins can be present in a weight ratio from about 1:5 to about 1:700. In some aspects, the lecithin and the one or more oilseed proteins can be present in a weight ratio from about 1:5 to about 1:600. In some aspects, the lecithin and the one or more oilseed proteins can be present in a weight ratio from about 1:5 to about 1:500. In some aspects, the lecithin and the one or more oilseed proteins can be present in a weight ratio from about 1:5 to about 1:400. In some aspects, the lecithin and the one or more oilseed proteins can be present in a weight ratio from about 1:5 to about 1:300. In some aspects, the lecithin and the one or more oilseed proteins can be present in a weight ratio from about 1:5 to about 1:200. In some aspects, the lecithin and the one or more oilseed proteins can be present in a weight ratio from about 1:5 to about 1:100. In some aspects, the lecithin and the one or more oilseed proteins can be present in a weight ratio from about 1:5 to about 1:90. In some aspects, the lecithin and the one or more oilseed proteins can be present in a weight ratio from about 1:5 to about 1:80. In some aspects, the lecithin and the one or more oilseed proteins can be present in a weight ratio from about 1:5 to about 1:70. In some aspects, the lecithin and the one or more oilseed proteins can be present in a weight ratio from about 1:5 to about 1:60. In some aspects, the lecithin and the one or more oilseed proteins can be present in a weight ratio from about 1:5 to about 1:50. In some aspects, the lecithin and the one or more oilseed proteins can be present in a weight ratio from about 1:5 to about 1:40. In some aspects, the lecithin and the one or more oilseed proteins can be present in a weight ratio from about 1:5 to about 1:30. In some aspects, the lecithin and the one or more oilseed proteins can be present in a weight ratio from about 1:5 to about 1:20. In some aspects, the lecithin and the one or more oilseed proteins can be present in a weight ratio from about 1:5 to about 1:10.

In some aspects, the beverage can further comprise one or more plant-based proteins selected from the group consisting of one or more pulse proteins, one or more cereal proteins, and a mixture thereof. In some aspects, the one or more pulse proteins can be selected from the group consisting of pea protein, bean protein, chickpea protein, lentil protein, and a mixture thereof. In some aspects, the one or more cereal proteins can be selected from the group consisting of rice protein, wheat protein, corn protein, barley protein, oat protein, millet protein, sorghum protein, rye protein, and a mixture thereof.

In some aspects, the one or more plant based proteins can be a mixture of one or more pulse proteins and one or more cereal proteins. In some aspects, the one or more plant based proteins can be a mixture of pea protein and rice protein.

In some aspects, the beverage can comprise from about 1 wt % to about 20 wt % of one or more plant based proteins. In some aspects, the beverage can comprise from about 2 wt % to about 19 wt % of one or more plant based proteins. In some aspects, the beverage can comprise from about 3 wt % to about 18 wt % of one or more plant based proteins. In some aspects, the beverage can comprise from about 4 wt % to about 17 wt % of one or more plant based proteins. In some aspects, the beverage can comprise from about 5 wt % to about 16 wt % of one or more plant based proteins. In some aspects, the beverage can comprise from about 5 wt % to about 15 wt % of one or more plant based proteins. In some aspects, the beverage can comprise from about 6 wt % to about 14 wt % of one or more plant based proteins. In some aspects, the beverage can comprise from about 7 wt % to about 13 wt % of one or more plant based proteins. In some aspects, the beverage can comprise from about 8 wt % to about 12 wt % of one or more plant based proteins. In some aspects, the beverage can comprise about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, 19 wt %, or about 20 wt % of one or more plant-based proteins.

In some aspects, the one or more plant based proteins can be a mixture of pea protein and rice protein. In some aspects, the beverage can comprise from about 1 wt % to about 20 wt % of a mixture of pea protein and rice protein. In some aspects, the beverage can comprise from about 2 wt % to about 19 wt % of a mixture of pea protein and rice protein. In some aspects, the beverage can comprise from about 3 wt % to about 18 wt % a mixture of pea protein and rice protein. In some aspects, the beverage can comprise from about 4 wt % to about 17 wt % of a mixture of pea protein and rice protein. In some aspects, the beverage can comprise from about 5 wt % to about 16 wt % of a mixture of pea protein and rice protein. In some aspects, the beverage can comprise from about 5 wt % to about 15 wt % of a mixture of pea protein and rice protein. In some aspects, the beverage can comprise from about 6 wt % to about 14 wt % of a mixture of pea protein and rice protein. In some aspects, the beverage can comprise from about 7 wt % to about 13 wt % of a mixture of pea protein and rice protein. In some aspects, the beverage can comprise from about 8 wt % to about 12 wt % of a mixture of pea protein and rice protein. In some aspects, the beverage can comprise about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, 19 wt %, or about 20 wt % of a mixture of pea protein and rice protein.

In some aspects, the one or more plant based proteins can be a mixture of one or more pulse proteins and one or more cereal proteins. In some aspects, the one or more pulse proteins and the one or more cereal proteins can be present in a weight ratio from about 1:1 to about 30:1. In some aspects, the one or more pulse proteins and the one or more cereal proteins can be present in a weight ratio from about 2:1 to about 28:1. In some aspects, the one or more pulse proteins and the one or more cereal proteins can be present in a weight ratio from about 3:1 to about 26:1. In some aspects, the one or more pulse proteins and the one or more cereal proteins can be present in a weight ratio from about 4:1 to about 24:1. In some aspects, the one or more pulse proteins and the one or more cereal proteins can be present in a weight ratio from about 5:1 to about 22:1. In some aspects, the one or more pulse proteins and the one or more cereal proteins can be present in a weight ratio from about 6:1 to about 20:1. In some aspects, the one or more pulse proteins and the one or more cereal proteins can be present in a weight ratio from about 7:1 to about 20:1. In some aspects, the one or more pulse proteins and the one or more cereal proteins can be present in a weight ratio from about 8:1 to about 20:1. In some aspects, the one or more pulse proteins and the one or more cereal proteins can be present in a weight ratio from about 9:1 to about 20:1. In some aspects, the one or more pulse proteins and the one or more cereal proteins can be present in a weight ratio from about 10:1 to about 20:1. In some aspects, the one or more pulse proteins and the one or more cereal proteins can be present in a weight ratio from about 11:1 to about 20:1. In some aspects, the one or more pulse proteins and the one or more cereal proteins can be present in a weight ratio from about 12:1 to about 20:1. In some aspects, the one or more pulse proteins and the one or more cereal proteins can be present in a weight ratio from about 13:1 to about 19:1.

In some aspects, the one or more plant based proteins can be a mixture of pea protein and rice protein. In some aspects, the pea protein and the rice protein can be present in a weight ratio from about 1:1 to about 30:1. In some aspects, the pea protein and the rice protein can be present in a weight ratio from about 2:1 to about 28:1. In some aspects the pea protein and the rice protein can be present in a weight ratio from about 3:1 to about 26:1. In some aspects, the pea protein and the rice protein can be present in a weight ratio from about 4:1 to about 24:1. In some aspects, the pea protein and the rice protein can be present in a weight ratio from about 5:1 to about 22:1. In some aspects, the pea protein and the rice protein can be present in a weight ratio from about 6:1 to about 20:1. In some aspects, the pea protein and the rice protein can be present in a weight ratio from about 7:1 to about 20:1. In some aspects, the pea protein and the rice protein can be present in a weight ratio from about 8:1 to about 20:1. In some aspects, the pea protein and the rice protein can be present in a weight ratio from about 9:1 to about 20:1. In some aspects, the pea protein and the rice protein can be present in a weight ratio from about 10:1 to about 20:1. In some aspects, the pea protein and the rice protein can be present in a weight ratio from about 11:1 to about 20:1. In some aspects, the pea protein and the rice protein can be present in a weight ratio from about 12:1 to about 20:1. In some aspects, the pea protein and the rice protein can be present in a weight ratio from about 13:1 to about 19:1.

In certain aspects, the beverage can further comprise one or more oils selected from the group consisting of soybean oil, sunflower oil, vegetable oil, rapeseed oil, olive oil, hempseed oil, avocado oil, flaxseed oil, peanut oil, coconut oil, sesame oil, and corn oil. In some aspects, the one or more oils can be sunflower oil.

In some aspects, the one or more oils can be present in the beverage in an amount from about 0.05 wt % to about 1 wt %. In some aspects, the one or more oils can be present in the beverage in an amount from about 0.06 wt % to about 0.9 wt %. In some aspects, the one or more oils can be present in the beverage in an amount from about 0.07 wt % to about 0.8 wt %. In some aspects, the one or more oils can be present in the beverage in an amount from about 0.08 wt % to about 0.7 wt %. In some aspects, the one or more oils can be present in the beverage in an amount from about 0.09 wt % to about 0.6 wt %. In some aspects, the one or more oils can be present in the beverage in an amount from about 0.1 wt % to about 0.5 wt %. In some aspects, the one or more oils can be present in the beverage in an amount of about 0.05 wt %, about 0.06 wt %, about 0.07 wt %, about 0.08 wt %, about 0.09 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.30 wt %, about 0.31 wt %, about 0.32 wt %, about 0.33 wt %, about 0.34 wt %, about 0.35 wt %, about 0.36 wt %, about 0.37 wt %, about 0.38 wt %, about 0.39 wt %, about 0.40 wt %, about 0.41 wt %, about 0.42 wt %, about 0.43 wt %, about 0.44 wt %, about 0.45 wt %, about 0.46 wt %, about 0.47 wt %, about 0.48 wt %, about 0.49 wt %, about 0.50 wt %, about 0.51 wt %, about 0.52 wt %, about 0.53 wt %, about 0.54 wt %, about 0.55 wt %, about 0.56 wt %, about 0.57 wt %, about 0.58 wt %, about 0.59 wt %, about 0.60 wt %, about 0.61 wt %, about 0.62 wt %, about 0.63 wt %, about 0.64 wt %, about 0.65 wt %, about 0.66 wt %, about 0.67 wt %, about 0.68 wt %, about 0.69 wt %, about 0.70 wt %, about 0.71 wt %, about 0.72 wt %, about 0.73 wt %, about 0.74 wt %, about 0.75 wt %, about 0.76 wt %, about 0.77 wt %, about 0.78 wt %, about 0.79 wt %, about 0.80 wt %, about 0.81 wt %, about 0.82 wt %, about 0.83 wt %, about 0.84 wt %, about 0.85 wt %, about 0.86 wt %, about 0.87 wt %, about 0.88 wt %, about 0.89 wt %, about 0.90 wt %, about 0.91 wt %, about 0.92 wt %, about 0.93 wt %, about 0.94 wt %, about 0.95 wt %, about 0.96 wt %, about 0.97 wt %, about 0.98 wt %, about 0.99 wt %, or about 1 wt %.

In some aspects, the one or more oils can be sunflower oil. In some aspects, the sunflower oil can be present in the beverage in an amount from about 0.05 wt % to about 1 wt %. In some aspects, the sunflower oil can be present in the beverage in an amount from about 0.06 wt % to about 0.9 wt %. In some aspects, the sunflower oil can be present in the beverage in an amount from about 0.07 wt % to about 0.8 wt %. In some aspects, the sunflower oil can be present in the beverage in an amount from about 0.08 wt % to about 0.7 wt %. In some aspects, the sunflower oil can be present in the beverage in an amount from about 0.09 wt % to about 0.6 wt %. In some aspects, the sunflower oil can be present in the beverage in an amount from about 0.1 wt % to about 0.5 wt %. In some aspects, the sunflower oil can be present in the beverage in an amount of about 0.05 wt %, about 0.06 wt %, about 0.07 wt %, about 0.08 wt %, about 0.09 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.30 wt %, about 0.31 wt %, about 0.32 wt %, about 0.33 wt %, about 0.34 wt %, about 0.35 wt %, about 0.36 wt %, about 0.37 wt %, about 0.38 wt %, about 0.39 wt %, about 0.40 wt %, about 0.41 wt %, about 0.42 wt %, about 0.43 wt %, about 0.44 wt %, about 0.45 wt %, about 0.46 wt %, about 0.47 wt %, about 0.48 wt %, about 0.49 wt %, about 0.50 wt %, about 0.51 wt %, about 0.52 wt %, about 0.53 wt %, about 0.54 wt %, about 0.55 wt %, about 0.56 wt %, about 0.57 wt %, about 0.58 wt %, about 0.59 wt %, about 0.60 wt %, about 0.61 wt %, about 0.62 wt %, about 0.63 wt %, about 0.64 wt %, about 0.65 wt %, about 0.66 wt %, about 0.67 wt %, about 0.68 wt %, about 0.69 wt %, about 0.70 wt %, about 0.71 wt %, about 0.72 wt %, about 0.73 wt %, about 0.74 wt %, about 0.75 wt %, about 0.76 wt %, about 0.77 wt %, about 0.78 wt %, about 0.79 wt %, about 0.80 wt %, about 0.81 wt %, about 0.82 wt %, about 0.83 wt %, about 0.84 wt %, about 0.85 wt %, about 0.86 wt %, about 0.87 wt %, about 0.88 wt %, about 0.89 wt %, about 0.90 wt %, about 0.91 wt %, about 0.92 wt %, about 0.93 wt %, about 0.94 wt %, about 0.95 wt %, about 0.96 wt %, about 0.97 wt %, about 0.98 wt %, about 0.99 wt %, or about 1 wt %.

In certain aspects, the lecithin in the beverage described herein can be hydrolyzed lecithin, and the beverage can comprise, in addition to the hydrolyzed lecithin, from about 0.05 wt % to about 20 wt % of one or more oilseed proteins, from about 1 wt % to about 20 wt % of one or more plant-based proteins, and from about 0.05 wt % to about 1 wt % of one or more oils, wherein the hydrolyzed lecithin and the one or more oilseed proteins can be present in a ratio of from about 1:1 to about 1:1400. In some aspects, the beverages can comprise hydrolyzed lecithin, from about 0.1 wt % to about 10 wt % of one or more oilseed proteins, from about 8 wt % to about 12 wt % of one or more plant-based proteins, and from about 0.1 wt % to about 0.5 wt % of one or more oils, wherein the hydrolyzed lecithin and the one or more oilseed proteins can be present in a ratio of from about 1:1 to about 1:50. In some aspects, the beverages can comprise hydrolyzed lecithin, from about 0.1 wt % to about 5 wt % of one or more oilseed proteins, from about 5 wt % to about 15 wt % of one or more plant-based proteins, and from about 0.07 wt % to about 0.8 wt % of one or more oils, wherein the hydrolyzed lecithin and the one or more oilseed proteins can be present in a ratio of from about 1:5 to about 1:10.

In certain aspects, the beverages can comprise hydrolyzed lecithin, from about 0.05 wt % to about 20 wt % of canola protein, from about 1 wt % to about 20 wt % of a mixture of pea protein and rice protein, and from about 0.05 wt % to about 1 wt % of sunflower oil, wherein the hydrolyzed lecithin and the canola protein can be present in a ratio of from about 1:1 to about 1:1400. In some aspects, the beverages can comprise hydrolyzed lecithin, from about 0.1 wt % to about 10 wt % of canola protein, from about 8 wt % to about 12 wt % of a mixture of pea protein and rice protein, and from about 0.1 wt % to about 0.5 wt % of sunflower oil, wherein the hydrolyzed lecithin and the canola protein can be present in a ratio of from about 1:1 to about 1:50. In some aspects, the beverages can comprise hydrolyzed lecithin, from about 0.1 wt % to about 5 wt % of canola protein, from about 5 wt % to about 15 wt % of a mixture of pea protein and rice protein, and from about 0.07 wt % to about 0.8 wt % of sunflower oil, wherein the hydrolyzed lecithin and the canola protein can be present in a ratio of from about 1:5 to about 1:10.

In certain aspects, the beverage can further comprise one or more hydrocolloids. In some aspects, the one or more hydrocolloids can be selected from the group consisting of guar gum, gellan gum, carrageenan, agar, xanthan gum, locust bean gum, cellulose gum, cellulose gel, pectin, methylcellulose, inulin, acacia and combinations thereof. In some aspects, the one or more hydrocolloids comprises gellan gum.

In some aspects, the one or more hydrocolloids can be present in the beverage in an amount from about 0.01 wt % to about 0.5 wt %. In some aspects, the one or more hydrocolloids can be present in the beverage in an amount from about 0.01 wt % to about 0.4 wt %. In some aspects, the one or more hydrocolloids can be present in the beverage in an amount from about 0.01 wt % to about 0.3 wt %. In some aspects, the one or more hydrocolloids can be present in the beverage in an amount from about 0.01 wt % to about 0.2 wt %. In some aspects, the one or more hydrocolloids can be present in the beverage in an amount from about 0.01 wt % to about 0.1 wt %. In some aspects, the one or more hydrocolloids can be present in the beverage in an amount from about 0.02 wt % to about 0.08 wt %. In some aspects, the one or more hydrocolloids can be present in the beverage in an amount of from about 0.02 wt % to about 0.06 wt %. In some aspects, the one or more hydrocolloids can be present in the beverage in an amount of about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.30 wt %, about 0.31 wt %, about 0.32 wt %, about 0.33 wt %, about 0.34 wt %, about 0.35 wt %, about 0.36 wt %, about 0.37 wt %, about 0.38 wt %, about 0.39 wt %, about 0.40 wt %, about 0.41 wt %, about 0.42 wt %, about 0.43 wt %, about 0.44 wt %, about 0.45 wt %, about 0.46 wt %, about 0.47 wt %, about 0.48 wt %, about 0.49 wt %, or about 0.50 wt %.

In some aspects, the beverage can comprise from about 0.01 wt % to about 0.5 wt % of gellan gum. In some aspects, the beverage can comprise from about 0.01 wt % to about 0.4 wt %% of gellan gum. In some aspects, the beverage can comprise from about 0.01 wt % to about 0.3 wt % of gellan gum. In some aspects, the beverage can comprise from about 0.01 wt % to about 0.2 wt % of gellan gum. In some aspects, the beverage can comprise from amount from about 0.01 wt % to about 0.1 wt % of gellan gum. In some aspects, the beverage can comprise from about 0.02 wt % to about 0.08 wt % of gellan gum. In some aspects, the beverage can comprise from about 0.02 wt % to about 0.06 wt %% of gellan gum. In some aspects, the beverage can comprise about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.30 wt %, about 0.31 wt %, about 0.32 wt %, about 0.33 wt %, about 0.34 wt %, about 0.35 wt %, about 0.36 wt %, about 0.37 wt %, about 0.38 wt %, about 0.39 wt %, about 0.40 wt %, about 0.41 wt %, about 0.42 wt %, about 0.43 wt %, about 0.44 wt %, about 0.45 wt %, about 0.46 wt %, about 0.47 wt %, about 0.48 wt %, about 0.49 wt %, or about 0.50 wt % of gellan gum.

In certain aspects, the beverage can comprise further one or more sweeteners. Suitable sweeteners include, but are not limited to, caloric carbohydrate sweeteners, natural high-potency sweeteners, synthetic high-potency sweeteners, other sweeteners, and combinations thereof.

Examples of suitable caloric carbohydrate sweeteners include sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (e.g., HFCS55, HFCS42, or HFCS90), coupling sugars, soybean oligosaccharides, and glucose syrup. In some aspects, the one or more sweeteners can be sucrose.

As used herein, the phrase “natural high-potency sweetener,” includes, but is not limited to, rebaudioside A, rebaudioside B, rebaudioside C (dulcoside B), rebaudioside D, rebaudioside E, rebaudioside F, rebaudioside H, rebaudioside I, rebaudioside J, rebaudioside K, rebaudioside L, rebaudioside M, rebaudioside N, rebaudioside O, rebaudioside R, rebaudioside S, rebaudioside T, rebaudioside U, rebaudioside V, dulcoside A, rubusoside, stevia, stevioside, mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, cyclocarioside I, and combinations thereof.

Natural high potency sweeteners also include modified natural high potency sweeteners. Modified natural high potency sweeteners include natural high potency sweeteners that have been altered either naturally or via a chemical or biosynthetic process, and include, but are not limited to, natural high potency sweeteners that have been fermented, contacted with enzyme, derivatized, or substituted. In some aspects, at least one modified natural high potency sweeteners can be used in combination with at least one natural high potency sweeteners. In other aspects, at least one modified natural high potency sweeteners can be used without a natural high potency sweeteners. Modified natural high potency sweeteners can be substituted for a natural high potency sweeteners or can be used in combination with natural high potency sweeteners for any of the aspects described herein.

As used herein, the phrase “synthetic sweetener” refers to any composition that is not found in nature and is a high potency sweetener. Non-limiting examples of synthetic sweeteners suitable for use in the beverages described herein include, but are not limited to, sucralose, acesulfame potassium, aspartame, alitame, saccharin, neohesperidin dihydrochalcone, cyclamate, neotame, N-[3-(3-hydroxy-4-methoxyphenyl)propyl]-L-a-aspartyl]-L-phenylalanine 1-methyl ester, N-[3-(3-hydroxy-4-methoxyphenyl)-3-methylbutyl]-L-a-aspartyl]-Lphenylalanine 1-methyl ester, N-[3-(3-methoxy-4-hydroxyphenyl)propyl]-L-a-aspartyl]-L-phenylalanine 1-methyl ester, salts thereof (as appropriate), and combinations thereof.

In some aspects, the beverage can comprise one or more carbohydrate sweeteners in an amount from about 0.25 wt % to about 20 wt %. In some aspects, the beverage can comprise one or more carbohydrate sweeteners in an amount from about 0.3 wt % to about 15 wt %. In some aspects, the beverage can comprise one or more carbohydrate sweeteners in an amount from about 0.4 wt % to about 10 wt %. In some aspects, the beverage can comprise one or more carbohydrate sweeteners in an amount from about 0.4 wt % to about 9 wt %. In some aspects, the beverage can comprise one or more carbohydrate sweeteners in an amount from about 0.5 wt % to about 8 wt %. In some aspects, the beverage can comprise one or more carbohydrate sweeteners in an amount from about 0.5 wt % to about 5 wt %. In some aspects, the beverage can comprise one or more carbohydrate sweeteners in an amount of about 0.25 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, or about 20 wt %.

In some aspects, the one or more carbohydrate sweeteners can be sucrose. In some aspects, the beverage can comprise sucrose in an amount from about 0.25 wt % to about 20 wt %. In some aspects, the beverage can comprise sucrose in an amount from about 0.3 wt % to about 15 wt %. In some aspects, the beverage can comprise sucrose in an amount from about 0.4 wt % to about 10 wt %. In some aspects, the beverage can comprise sucrose in an amount from about 0.4 wt % to about 9 wt %. In some aspects, the beverage can comprise sucrose in an amount from about 0.5 wt % to about 8 wt %. In some aspects, the beverage can comprise sucrose in an amount from about 0.5 wt % to about 5 wt %. In some aspects, the beverage can comprise sucrose in an amount of about 0.25 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, or about 20 wt %.

In some aspects, the beverage can comprise one or more natural high potency sweeteners in an amount from about 0.1 ppm to about 700 ppm. In some aspects, the beverage can comprise one or more natural high potency sweeteners in an amount from about 0.5 ppm to about 600 ppm. In some aspects, the beverage can comprise one or more natural high potency sweeteners in an amount from about 1 ppm to about 500 ppm. In some aspects, the beverage can comprise one or more natural high potency sweeteners in an amount from about 2 ppm to about 400 ppm. In some aspects, the beverage can comprise one or more natural high potency sweeteners in an amount from about 3 ppm to about 300 ppm. In some aspects, the beverage can comprise one or more natural high potency sweeteners in an amount from about 0.1 ppm to about 280 ppm. In some aspects, the beverage can comprise one or more natural high potency sweeteners in an amount of about 0.1 ppm, about 0.5 ppm, about 1 ppm, about 5 ppm, about 10 ppm, about 15 ppm, about 20 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, about 100 ppm, about 125 ppm, about 150 ppm, about 175 ppm, about 200 ppm, about 225 ppm, about 250 ppm, about 275 ppm, about 300 ppm, about 325 ppm, about 350 ppm, about 375 ppm, about 400 ppm, about 425 ppm, about 450 ppm, about 475 ppm, about 500 ppm, about 525 ppm, about 550 ppm, about 575 ppm, about 600 ppm, about 625 ppm, about 650 ppm, about 675 ppm, or about 700 ppm.

In some aspects, the one or more natural high potency sweeteners can be rebaudioside A, rebaudioside B, rebaudioside C (dulcoside B), rebaudioside D, rebaudioside E, rebaudioside F, rebaudioside H, rebaudioside I, rebaudioside J, rebaudioside K, rebaudioside L, rebaudioside M, rebaudioside N, rebaudioside O, rebaudioside R, rebaudioside S, rebaudioside T, rebaudioside U, rebaudioside V, dulcoside A, rubusoside, stevia, stevioside, mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, cyclocarioside I, or a combination thereof. In some aspects, the one or more natural high potency sweeteners can be rebaudioside A, rebaudioside B, rebaudioside C, rebaudioside D, rebaudioside M, rebaudioside F, rebaudioside J, or a mixture thereof.

In some aspects, the beverage can comprise rebaudioside A, rebaudioside B, rebaudioside C, rebaudioside D, rebaudioside M, rebaudioside F, rebaudioside J, or a mixture thereof in an amount from about 0.1 ppm to about 700 ppm. In some aspects, the beverage can comprise rebaudioside A, rebaudioside B, rebaudioside C, rebaudioside D, rebaudioside M, rebaudioside F, rebaudioside J, or a mixture thereof in an amount from about 0.5 ppm to about 600 ppm. In some aspects, the beverage can comprise rebaudioside A, rebaudioside B, rebaudioside C, rebaudioside D, rebaudioside M, rebaudioside F, rebaudioside J, or a mixture thereof in an amount from about 1 ppm to about 500 ppm. In some aspects, the beverage can comprise rebaudioside A, rebaudioside B, rebaudioside C, rebaudioside D, rebaudioside M, rebaudioside F, rebaudioside J, or a mixture thereof in an amount from about 2 ppm to about 400 ppm. In some aspects, the beverage can comprise rebaudioside A, rebaudioside B, rebaudioside C, rebaudioside D, rebaudioside M, rebaudioside F, rebaudioside J, or a mixture thereof in an amount from about 3 ppm to about 300 ppm. In some aspects, the beverage can comprise rebaudioside A, rebaudioside B, rebaudioside C, rebaudioside D, rebaudioside M, rebaudioside F, rebaudioside J, or a mixture thereof in an amount from about 0.1 ppm to about 280 ppm. In some aspects, the beverage can comprise rebaudioside A, rebaudioside B, rebaudioside C, rebaudioside D, rebaudioside M, rebaudioside F, rebaudioside J, or a mixture thereof in an amount of about 0.1 ppm, about 0.5 ppm, about 1 ppm, about 5 ppm, about 10 ppm, about 15 ppm, about 20 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, about 100 ppm, about 125 ppm, about 150 ppm, about 175 ppm, about 200 ppm, about 225 ppm, about 250 ppm, about 275 ppm, about 300 ppm, about 325 ppm, about 350 ppm, about 375 ppm, about 400 ppm, about 425 ppm, about 450 ppm, about 475 ppm, about 500 ppm, about 525 ppm, about 550 ppm, about 575 ppm, about 600 ppm, about 625 ppm, about 650 ppm, about 675 ppm, or about 700 ppm.

In some aspects, the beverage can comprise one or more dairy sources. Suitable dairy sources include, but are not limited to, milk (for example, whole milk, reduced fat milk, skim milk, or a combination thereof), cream, or a combination thereof. In some aspects, the one or more dairy sources can comprise a combination of milk and cream. In some aspects, the one or more dairy sources can comprise a combination of skim milk and cream. In some aspects, the one or more dairy sources can comprise a combination of condensed skim milk and cream.

In some aspects, the beverage can further include additional ingredients, including, generally, any of those typically found in beverage compositions. Examples of such additional ingredients include, but are not limited to, caramel and other coloring agents or dyes, flavoring agents, foaming agents, gums, emulsifiers, tea solids, cloud components, and mineral and non-mineral nutritional supplements. Examples of flavoring agents include, but are not limited to, salt, caramel flavor, vanilla flavor, chocolate flavor, hazelnut flavor, strawberry flavor, raspberry flavor, and mint flavor. Examples of non-mineral nutritional supplement ingredients are known to those of ordinary skill in the art and include, for example, antioxidants and vitamins, including Vitamins A, D, E (tocopherol), C (ascorbic acid), B (thiamine), B2 (riboflavin), B6, B12, K, niacin, folic acid, biotin, and combinations thereof. The optional non-mineral nutritional supplements are typically present in amounts generally accepted under good manufacturing practices. Exemplary amounts can be between about 1% and about 100% of the United States Recommended Daily Value (RDV). In certain exemplary aspects the non-mineral nutritional supplement ingredient(s) can be present in an amount of from about 5% to about 20% RDV, where established.

The beverage described herein can also optionally include one or more processing aids. Processing aids can be used to improve product quality and consistency, enhance nutrition, maintain product wholesomeness, enhance shelf life, and assist with packing and transportation. In some aspects, processing aids can comprise substances such as potassium carbonate, potassium citrate, sodium citrate, sodium ascorbate, sodium bicarbonate, sodium carbonate, acetic acid, ascorbic acid, citric acid, phosphoric acid, malic acid, tripotassium phosphate, dipotassium phosphate, monopotassium phosphate, sodium hydroxide, potassium hydroxide, and antifoaming agent as well as agents such as antimicrobial agents. In some aspects, processing aids can comprise dipotassium phosphate and one or more antifoaming agents.

In some aspects, the viscosity of the beverage after heat treatment can be from about 15 cP to about 250 cP when measured at about 20° C. and about 60 RPM. In some aspects, the viscosity can be from about 15 cP to about 200 cP when measured at about 20° C. and about 60 RPM. In some aspects, the viscosity can be from about 15 cP to about 150 cP when measured at about 20° C. and about 60 RPM. In some aspects, the viscosity can be from about 15 cP to about 100 cP when measured at about 20° C. and about 60 RPM. In some aspects, the viscosity can be from about 15 cP to about 90 cP when measured at about 20° C. and about 60 RPM. In some aspects, the viscosity can be from about 15 cP to about 80 cP when measured at about 20° C. and about 60 RPM. In some aspects, the viscosity can be from about 15 cP to about 70 cP when measured at about 20° C. and about 60 RPM. In some aspects, the viscosity can be from about 25 cP to about 55 cP when measured at about 20° C. and about 60 RPM. In some aspects, the can be from about 30 cP to about 50 cP when measured at about 20° C. and about 60 RPM. In some aspects, the viscosity can be from about 30 cP to about 40 cP when measured at about 20° C. and about 60 RPM. In some aspects, the viscosity can be about 15 cP, about 20 cP, about 25 cP, about 30 cP, about 35 cP, about 40 cP, about 45 cP, about 50 cP, about 55 cP, about 60 cP, about 65 cP, about 70 cP, about 75 cP, about 80 cP, about 85 cP, about 90 cP, about 95 cP, about 100 cP, about 110 cP, about 120 cP, about 130 cP, about 140 cP, about 150 cP, about 200 cP, or about 250 cP, when measured at about 20° C. and about 60 RPM. In some aspects, the viscosity can be under about 250 cP, under about 200 cP, under about 150 cP, under about 140 cP, under about 130 cP, under about 120 cP, under about 110 cP, under about 100 cP, under about 95 cP, under about 90 cP, under about 85 cP, under about 80 cP, under about 75 cP, under about 70 cP, under about 65 cP, under about 60 cP, under about 55 cP, under about 50 cP, under about 45 cP, under about 40 cP, or under about 30 cP when measured at about 20° C. and about 60 RPM. Viscosity is measured according to the procedure described in Example 2.

In some aspects, from about 50% to about 95% of the protein in the beverage can be solubilized in the beverage after heat treatment. In some aspects, from about 55% to about 95% of the protein in the beverage can be solubilized in the beverage In some aspects, from about 60% to about 95% of the protein in the beverage can be solubilized in the beverage. In some aspects, from about 65% to about 95% of the protein in the beverage can be solubilized in the beverage. In some aspects, from about 70% to about 95% of the protein in the beverage can be solubilized in the beverage. In some aspects, from about 75% to about 95% of the protein in the beverage can be solubilized in the beverage. In some aspects, from about 80% to about 95% of the protein in the beverage can be solubilized in the beverage. In some aspects, from about 85% to about 95% of the protein in the beverage can be solubilized in the beverage. In some aspects, about 50%, about 55%, about 60%, about 65%, about 70%, about 75%, about 80%, about 85%, about 90%, or about 95% of the protein in the beverage can be solubilized in the beverage. In some aspects, at least about 50%, at least about 55%, at least about 60%, at least about 65%, at least about 70%, at least about 75%, at least about 80%, at least about 85%, at least about 90%, or at least about 95% of the protein in the beverage can be solubilized in the beverage. Protein solubility can be measured according to the procedure described in Example 2.

In certain aspects, the beverage is shelf-stable. In some aspects, shelf-stable refers to the ability of the beverage to sit for an extended period of time at about 18° C. to about 27° C. without gelation and microbial spoilage. In certain aspects, the beverage can be stable at about 18° C. to about 27° C. for at least about one month. In some aspects, the beverage can be stable at about 18° C. to about 27° C. for at least about three months. In some aspects, the beverage can be stable at about 18° C. to about 27° C. for at least about six months. In some aspects the beverage can be stable at about 18° C. to about 27° C. for at least about twelve months.

### Processes

In some aspects, the beverage can be prepared by adding one or more oilseed proteins to an aqueous solution optionally comprising one or more processing aids to form a mixture and adding lecithin to the mixture to form a final mixture. In some aspects, the one or more oilseed proteins can be added to one or more plant-based proteins before the protein mixture is added to the aqueous solution. In some aspects, lecithin can be added to one or more oils prior to being added to the protein mixture/aqueous solution mix.

In some aspects, the final mixture can be subjected to thermal processing. In some aspects, thermal processing can comprise direct steam injection. In some aspects, thermal processing can comprise direct steam injection at a temperature of about 100° C. to about 160° C. In some aspects, thermal processing can comprise indirect heat treatment. In some aspects, thermal processing can comprise indirect heat treatment at a temperature of about 60° C. to about 100° C.

In certain aspects, the final mixture can be homogenized after thermal processing. In some aspects, the final mixture can be homogenized using in-line aseptic two-stage homogenization. In some aspects, the homogenization can be conducted at a total of about 1500 psi to about 3000 psi. In some aspects, the homogenization can be conducted at a total of about 2500 psi.

The aspects described herein are further detailed with reference to the examples shown below. These examples are provided for the purpose of illustration only and the aspects described herein should in no way be construed as being limited to these examples. Rather, the aspects should be construed to encompass any and all variations which become evident as a result of the teachings provided herein.

### EXAMPLES

### Example 1: Determination of Protein Solubility of Canola Protein Samples in the Presence and Absence of Lecithin

Three 75 mL liquid samples having 2% canola protein were prepared in 0.2 M sodium phosphate buffer. One sample was treated with 0.2% enzymatically hydrolyzed sunflower lecithin, and one was treated with 0.2% native sunflower lecithin, and one was not treated with lecithin (see Table 1).

TABLE 1
Canola Protein Samples

| Ingredient | Sample 1 | Sample 2 | Sample 3 |
|---|---|---|---|
| 0.2M Sodium Phosphate | 98% | 97.8% | 97.8% |
| Buffer | | | |
| Canola Protein | 2% | 2% | 2% |
| Native sunflower lecithin | 0% | 0.2% | 0% |
| Enzymatically hydrolyzed | 0% | 0% | 0.2% |
| sunflower lecithin | | | |

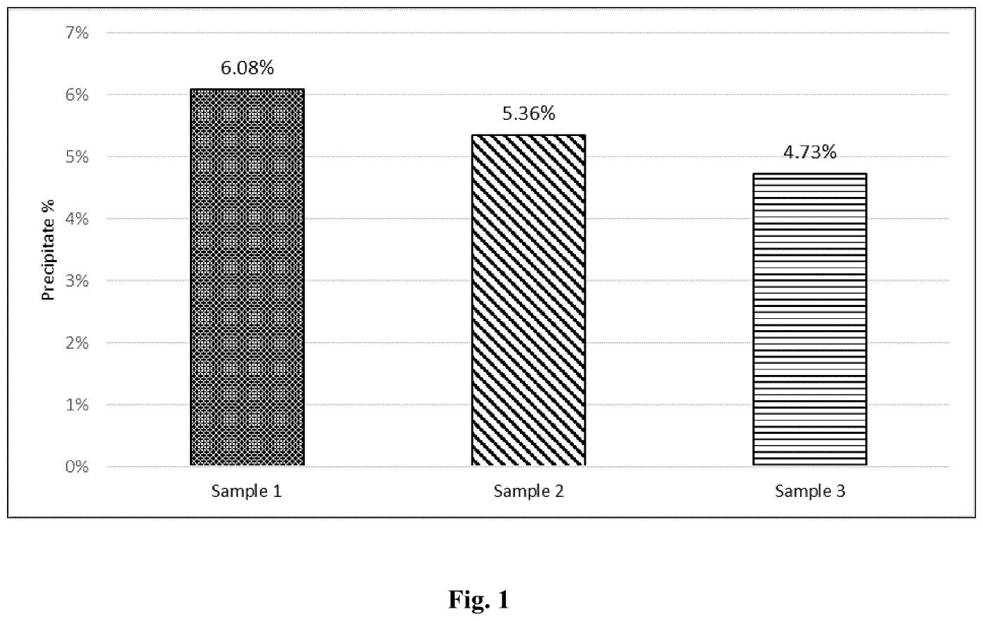

The samples were mixed for 2 hours at room temperature then stored overnight at 4° C. After overnight storage, the samples were stirred with a magnetic stirrer for 3 hours in ambient conditions to bring the temperature of the samples to room temperature (˜20° C.). The samples were then heat-treated using a PerkinElmer RVA (Rapid Visco Analyzer) 4800 as follows: The temperature of the samples were first increased to 50° C., then temperatures were continuously increased to 95° C. within 4 minutes and 42 seconds. The samples were then incubated at 95° C. for 5 minutes with continuous stirring at 160 rpm. After 5 minutes of heat treatment, the samples were cooled to 50° C. within 5 minutes and 18 seconds. The heat treated samples were then transferred into plastic cups with lids and stored at 4° C. overnight. The following day, about 10 g aliquots from each heat-treated sample were transferred into 15 mL centrifuge tubes and centrifuged at 6,500 rpm for 15 minutes. After the centrifugation, the supernatants were discarded, and the centrifuge tubes were kept upside down for 10 minutes to drain any remaining liquid. The pellets formed in each centrifuge tube were then weighed. The precipitate percentage was calculated by dividing the final weight of the pellets formed in each centrifuge tube by the initial weights of the 10 g liquid samples. Results are shown in FIG. 1.

As shown in the figure, when native lecithin and hydrolyzed lecithin were added to the canola protein samples, the precipitate percentages decreased. As protein solubility is a reflection of the heat stability of the solution, these results surprisingly suggested that the addition of lecithin increased the heat stability of the canola protein samples.

### Example 2: Determination of Protein Stability and Viscosity of Protein Beverages Containing Native and Hydrolyzed Lecithin

Three 1,000 g liquid protein beverage products were prepared containing the reagents shown in Table 2 and heat-treated with a bench-top oil bath at 140° C. for 15 seconds (which mimics ultra-high temperature (UHT) treatment that is applied to liquid beverage systems in the preparation of shelf-stable products). All formulations were designed to have 30 g of total protein per 325 mL serving size.

Antifoaming agent, salt blend (dipotassium phosphate, potassium chloride, sodium chloride), gellan gum, sucrose, and flavoring agent were first added into room temperature reverse osmosis (RO) water and mixed until all of the ingredients dissolved and dispersed in the water. A blend of proteins (blend of pea and rice proteins for formulation 1, and blend of pea, rice, and canola proteins for formulations 2 and 3) were added into the mixture and the batch was mixed for 15 minutes using an immersion blender. A blend of sunflower oil and lecithin (native or hydrolyzed) was added into the final batch while the immersion blender was running. The final batches were then homogenized using a two-stage homogenizer at 2,500 psi (172 Bar). The homogenized samples were filled into stainless-steel tubes with thermocouples, and the tubes were fully immersed into an oil bath. Once the internal temperature of the stainless-steel tubes reached 140° C., samples were kept for 15 seconds and then removed and placed outside of the oil-bath to stop the heat treatment. Once the temperature of the samples reached room temperature, the protein solubility and viscosity profiles of the samples were measured.

TABLE 2
Protein Beverage Formulations

| | Formulation | | Formulation | | Formulation | |
|---|---|---|---|---|---|---|
| Ingredient | 1 | | 2 | | 3 | |
| Reverse osmosis water | 860.3 | g | 862.3 | g | 862.3 | g |
| Antifoaming agent | 0.1 | g | 0.1 | g | 0.1 | g |
| Pea protein | 112 | g | 99 | g | 99 | g |
| Rice protein | 6.0 | g | 7.0 | g | 7.0 | g |
| Canola protein | 0.0 | g | 10 | g | 10 | g |
| Dipotassium phosphate | 3.3 | g | 3.3 | g | 3.3 | g |
| Potassium chloride | 0.7 | g | 0.7 | g | 0.7 | g |
| Sucrose | 9.0 | g | 9.0 | g | 9.0 | g |
| Sodium chloride | 0.3 | g | 0.3 | g | 0.3 | g |
| Flavoring agent | 2.0 | g | 2.0 | g | 2.0 | g |
| High oleic sunflower oil | 4.9 | g | 4.9 | g | 4.9 | g |
| Gellan gum | 0.4 | g | 0.4 | g | 0.4 | g |
| Native sunflower lecithin | 1.0 | g | 1.0 | g | 0.0 | g |
| Enzymatically hydrolyzed | 0.0 | g | 0.0 | g | 1.0 | g |
| sunflower lecithin | | | | | | |
| Total batch size | 1,000 | g | 1,000 | g | 1,000 | g |

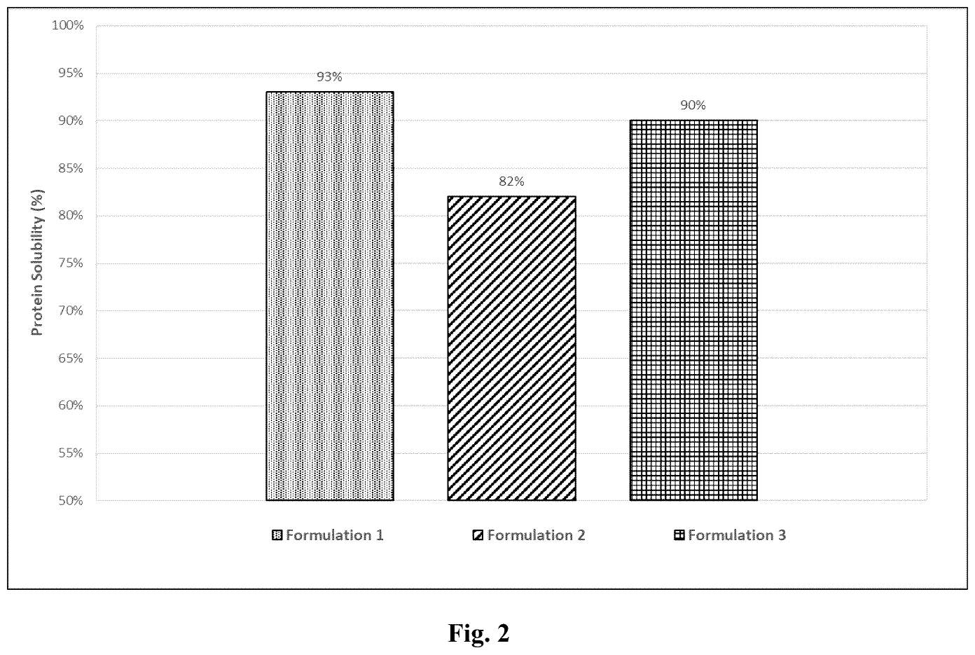

Protein solubility was determined as follows: About 13 g of the heat-treated samples were transferred into separate 15 mL centrifuge tubes. The tubes were then centrifuged at 5,000 RPM for 15 minutes. After centrifugation, the supernatant was collected from each tube. The initial heat-treated samples and the collected supernatants were analyzed for total protein content using the official method of analysis of AOAC (Association of Analytical Chemists) for protein analysis. The nitrogen factor of 6.25 was applied to convert nitrogen content to protein content. Results were received as percent protein. The protein solubility percentage was calculated by dividing the percent protein of supernatants by the percent protein of the heat-treated samples. As shown in FIG. 2, the presence of canola protein in formulation 2 affected the protein solubility value negatively as compared to formulation 1 (which did not contain canola protein). Formulation 3, which contained hydrolyzed lecithin instead of native lecithin, showed less of this effect. These results surprisingly showed that hydrolyzed lecithin improved the protein solubility of solutions containing canola protein.

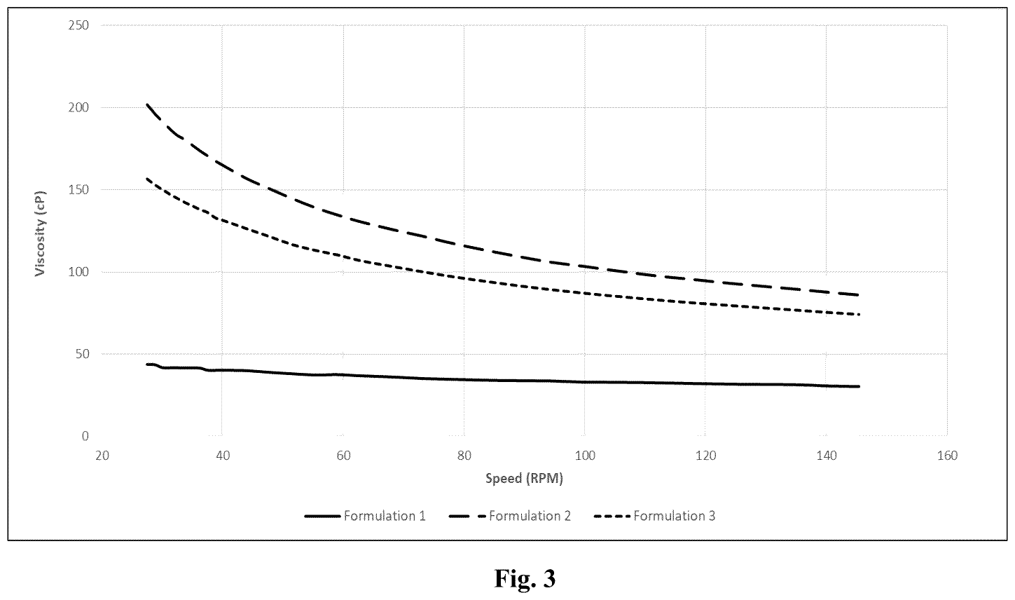

The viscosity profiles of the samples were measured using Brookfield DV3T-RV Rheometer with small adapter 13R and spindle SC4-21 at ambient temperature (˜20° C.). Sample volume was 8 ml. Viscosity data were collected at different speeds and reported in FIG. 3. As seen in the figure, the presence of the canola protein in formulations 2 and 3 increased the viscosity of the heat-treated samples significantly compared to formulation 1, which did not have the canola protein. However, the use of hydrolyzed lecithin in formulation 3 lowered the viscosity compared to sample 2, which contained native lecithin in formulation 2. Comparing these results with the solubilities shown in FIG. 2 demonstrate that the use of hydrolyzed lecithin increases protein solubility and decreases the viscosity of canola protein formulations, providing a more stable formulation.

### Example 3

Two 15 kg liquid protein beverage slurries were prepared using the formulations shown in Table 3 and processed in a pilot plant trial to create final protein beverage products. The formulations differed in the type of the lecithin that was used. Formulation 1 had native lecithin while formulation 2 had hydrolyzed lecithin. Both formulations were designed to have 30 g of total protein per 325 mL serving size.

Antifoaming agent, salt blend (dipotassium phosphate, potassium chloride, sodium chloride), gellan gum, sucrose, and flavoring agent were added into room temperature RO water and mixed using a high-shear immersion blender for 5 minutes. A blend of pea, rice and canola proteins were added into the batch and the batch was mixed using the high-shear immersion blender for another 5 minutes. Finally, the blend of sunflower oil and lecithin (native or hydrolyzed) was added into the final batch and the resulting mixture was mixed for 10 minutes. The final batch was then thermally processed using a direct steam injection via Microthermics pilot scale UHT equipment under the following processing conditions: Flow rate: 1 L/min., Pre-heat temperature: 190° F. (87.7° C.), Final-heat temperature: 292° F. (144.4° C.), residence time in the hold tube: 6 seconds, flash cool temperature: 185° F. (85° C.), and filling temperature: <70° F. (21.1 C). The hold tube internal pipe diameter was 0.95 cm and the pipe length was 140 cm. Products were also homogenized using an in-line aseptic two-stage homogenization step at total of 2,500 psi (172.4 Bar).

TABLE 3
Protein beverage formulation used in pilot scale trials.

| | | |
|---|---|---|
| Ingredient | Formulation 1 | Formulation 2 |

| | | | | |
|---|---|---|---|---|
| Reverse osmosis water | 12,935 | g | 12,935 | g |
| Antifoaming agent | 1.5 | g | 1.5 | g |
| Pea protein | 1479 | g | 1479 | g |
| Rice protein | 104 | g | 104 | g |
| Canola protein | 157 | g | 157 | g |
| Dipotassium phosphate | 49.2 | g | 49.2 | g |
| Potassium chloride | 10.5 | g | 10.5 | g |
| Sucrose | 135 | g | 135 | g |
| Sodium chloride | 4.5 | g | 4.5 | g |
| Flavoring agent | 30 | g | 30 | g |
| High oleic sunflower oil | 73.5 | g | 73.5 | g |
| Gellan gum | 5.3 | g | 5.3 | g |
| Native sunflower lecithin | 15.0 | g | 0.0 | g |
| Enzymatically hydrolyzed | 0.0 | g | 15.0 | g |
| sunflower lecithin | | | | |
| Total batch size | 15,000 | g | 15,000 | g |

As shown in FIGS. 2 and 3, the beverage with the hydrolyzed lecithin had a higher protein solubility and a lower viscosity proving the significant impact of the hydrolyzed lecithin to increase the solubility and the heat stability of canola proteins.

The breadth and scope of the present disclosure should not be limited by any of the above-described exemplary aspects, but should be defined only in accordance with the following claims and their equivalents.

All patents, patent applications, and other reference noted or referenced in this application are hereby incorporated by reference in their entireties.

1. A beverage comprising:
a. lecithin; and
b. one or more oilseed proteins;
wherein the beverage has one or both of the following:
i. a protein solubility of at least 80%; and
ii. a viscosity of less than 250 cP as measured at about 20° C. and 60 RPM.

2. The beverage of claim 1, wherein the lecithin is plant-derived lecithin.

3. The beverage of claim 1, wherein the lecithin is from sunflower.

4. The beverage of claim 1, wherein the lecithin is native.

5. The beverage of claim 1, wherein the lecithin is hydrolyzed.

6. The beverage of claim 1, wherein the one or more oilseed proteins is selected from the group consisting of canola protein, hemp seed protein, pumpkin seed protein, sesame seed protein, sunflower seed protein, chia seed protein, cotton seed protein, flax seed protein, and a mixture thereof.

7. The beverage of claim 1, wherein the one or more oilseed proteins is canola protein.

8. The beverage of claim 1, further comprising one or more plant-based proteins.

9. The beverage of claim 8, wherein the one or more plant-based proteins is selected from the group consisting of one or more pulse proteins, one or more cereal proteins, and a mixture thereof.

10. The beverage of claim 8, wherein the one or more plant-based proteins is a mixture of one or more pulse proteins and one or more cereal proteins.

11. The beverage of claim 9, wherein the one or more pulse proteins is selected from the group consisting of pea protein, bean protein, chickpea protein, lentil protein, and a mixture thereof.

12. The beverage of claim 9, wherein the one or more pulse proteins is pea protein.

13. The beverage of claim 9 to 12, wherein the one or more cereal proteins is selected from the group consisting of rice protein, wheat protein, corn protein, barley protein, oat protein, millet protein, sorghum protein, rye protein, and a mixture thereof.

14. The beverage of claim 9, wherein the one or more cereal proteins is rice protein.

15. The beverage of claim 9, wherein the one or more plant-based proteins is a mixture of pea protein and rice protein.

16. The beverage of claim 1, wherein the lecithin and one or more oilseed proteins are present in a weight ratio from about 1:5 to about 1:1000.

17. The beverage of claim 1, wherein the lecithin and the one or more oilseed proteins are present in a weight ratio from about 1:5 to about 1:30.

18. The beverage of claim 1, wherein the one or more oilseed proteins comprises from about 0.1 wt % to about 10 wt % by weight of the beverage.

19. The beverage of claim 1, wherein the one or more plant-based proteins comprises from about 5 wt % to about 15 wt % of the beverage.

20. The beverage of claim 1, further comprising one or more oils.

21. The beverage of claim 20 wherein the one or more oils is selected from the group consisting of soybean oil, sunflower oil, vegetable oil, rapeseed oil, olive oil, hempseed oil, avocado oil, flaxseed oil, peanut oil, coconut oil, sesame oil, corn oil, and a mixture thereof.

22. The beverage of claim 21 wherein the one or more oils is sunflower oil.

23. The beverage of claim 1, wherein the beverage further comprises one or more processing aids.

24. The beverage of claim 23 wherein the one or more processing aids are selected from the group consisting of potassium carbonate, sodium bicarbonate, sodium carbonate, ascorbic acid, citric acid, acetic acid, phosphoric acid, malic acid, tripotassium phosphate, sodium hydroxide, potassium hydroxide, dipotassium phosphate, and an antifoaming agent.

25. A method of preparing the beverage of claim 1, the method comprising adding one or more oilseed proteins to an aqueous solution optionally comprising one or more processing aids to form a mixture and adding lecithin to the mixture to form a final mixture.

26. The method of claim 25, further comprising subjecting the final mixture to thermal processing.

27. The method of claim 25, further comprising homogenizing the final mixture.
